(19) United States
(12) Patent Application Publication
(10) Pub. No.: US 2025/0283475 A1
(43) Pub. Date: Sep. 11, 2025

(54) CONNECTED VACUUM SYSTEM WITH SENSOR SUITE

(71) Applicant: Midmark Corporation, Versailles, OH (US)

(72) Inventors: Katie D. Hamilton, Piqua, OH (US); Kyle F. Bohman, Troy, OH (US); Ethan K. Bruns, Versailles, OH (US); Ronald W. Doucette, Troy, OH (US); Evan A. Freeh, Troy, OH (US); Kenneth P. Wolters, Minster, OH (US); William P. Zulauf, Dublin, OH (US)

(21) Appl. No.: 19/070,034

(22) Filed: Mar. 4, 2025

Related U.S. Application Data
(60) Provisional application No. 63/562,072, filed on Mar. 6, 2024.

(51) Int. Cl. F04D 27/00; A61C 19/00; F04D 25/06

(52) U.S. Cl. CPC F04D 27/001; F04D 25/06; F04D 27/007; A61C 19/002

(57) ABSTRACT

The disclosure relates to a connected vacuum system with a sensor suite. The system includes an vacuum system, an exam room control system, and an analytics system. Housed in a mechanical room, the vacuum system features a sensor suite that gathers data on various components and environmental factors, such as current, voltage, temperature, speed, position, pressure, dew point, vibration, and flow rate of various components. The collected data is then transmitted to a cloud-based analytics system, which offers thorough analysis, diagnoses, preventative maintenance, and timely alerts to reduce downtime and maintenance costs while enhancing system reliability. The exam room control system, located in the exam room, facilitates monitoring and tuning system parameters via a control panel. This reduces the need to leave the patient's side to attend to the vacuum system in the mechanical room, ultimately improving workflow efficiency and the overall patient experience.

### BACKGROUND

Dental offices require a reliable and efficient vacuum system to provide high-quality care to patients. However, existing vacuum systems have several drawbacks and limitations that can compromise their performance, reliability, and safety.

Existing vacuum systems in dental offices often rely on traditional technologies and manual processes. These systems can be inefficient and prone to unforeseen breakdowns, resulting in costly repairs and downtime for the dental practice. These systems and their accompanying control mechanisms are often located far from the dental treatment suite (e.g., in separate room or separate floor of the building that houses the dental treatment suite) due to the noise and heat that they create during operation. Changing or adjusting elements on these systems is often inconvenient and inefficient since it may require a dentist or dental office worker (hereinafter “dental practitioner”) to leave the primary dental treatment space and travel to the room where the vacuum system controls are located.

Moreover, these systems often lack advanced features and functionality that could improve their performance and ease of use. For example, existing systems may not have sensors to monitor various aspects of system status, resulting in reduced efficiency and increased maintenance needs. They may also lack preventative maintenance capabilities, which can help dental practices identify and address potential issues before they become major problems and result in down-time for the dental office.

Given these limitations and challenges, there is a need for an improved vacuum system for dental offices. Such a system should have advanced connectivity features and functionality, including the integration of sensor technologies and a control module to drive preventative maintenance capabilities. Such a system would provide improved performance, reliability, and safety, while reducing downtime and maintenance costs for dental practices.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a diagrammatic view of an exemplary operating environment of the present disclosure having an exemplary vacuum system, an exemplary exam room control system, and an exemplary analytics system connected via an exemplary network;

FIG. 2 depicts a diagrammatic view of an exemplary computer system for use in any of the systems or subsystems of FIG. 1 or described herein;

FIG. 3 depicts a diagrammatic view of an exemplary mechanical room connected to an exemplary exam room of the operating environment of FIG. 1;

FIG. 4 depicts a perspective view of an exemplary vacuum assembly for use in the vacuum system of FIG. 1;

FIG. 5 depicts another perspective view of the exemplary vacuum assembly of FIG. 4 with parts cut away to reveal exemplary pressure sensors and an exemplary filter;

FIG. 6 depicts a diagrammatic view of the air and vacuum system of FIG. 1; and

FIG. 7 depicts a diagrammatic view of the analytics system of FIG. 1 operatively connected to an exemplary interactive dashboard.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

### I. Connected Vacuum System with Sensor Suite

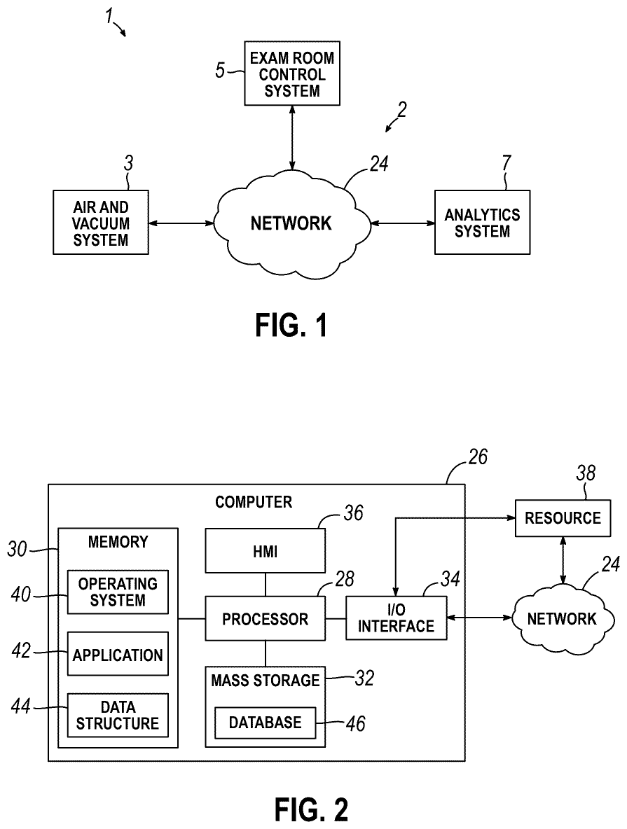

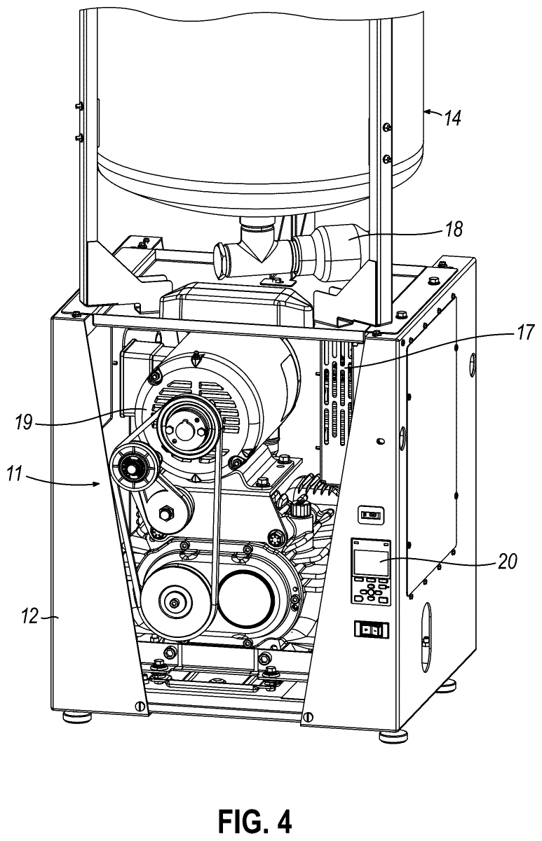

A connected vacuum system with sensor suite (1) is shown in FIGS. 1-7 and described herein. Connected vacuum system with a sensor suite (1) may alternatively be referred to hereinafter as connected system (1). As shown in FIG. 1, some versions of connected system (1) may include a vacuum system (3), an exam room control system (5), and an analytics system (7), as shown in an operating environment (2). These systems are set apart in FIG. 1 as operating environment (2) simply for ease of understanding and to aid in providing succinct disclosure. In practice, the various features and functionality discussed pertaining to vacuum system (3), exam room control system (5), and/or analytics system (7) may be located in different or overlapping environments, elements or modules, may be duplicated across elements, or may be replaced with generally equivalent features or elements.

In some versions of operating environment (2), vacuum system (3), exam room control system (5), and analytics system (7) may send and receive communications between one another directly. Alternatively, in other versions of operating environment (2), vacuum system (3), exam room control system (5), and analytics system (7) may communicate with each other through a network (24). Network (24) may include one or more private or public networks (e.g. the Internet) that enable the exchange of data.

Referring now to FIG. 2, vacuum system (3), exam room control system (5), and analytics system (7), and network (24) of operating environment (2) may be implemented on one or more computing devices or systems, such as an exemplary computer system (26). Computer system (26) may include a processor (28), a memory (30), a mass storage memory device (32), an input/output (I/O) interface (34), and a Human Machine Interface (HMI) (36). Computer system (26) may also be operatively coupled to one or more external resources (38) via network (24) or I/O interface (34). External resources may include, but are not limited to, servers, databases, mass storage devices, peripheral devices, cloud-based network services, or any other suitable computer resource that may be used by computer system (26).

Processor (28) may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory (30). Memory (30) may include a single memory device or a plurality of memory devices including, but not limited, to read-only memory (ROM), random access memory (RAM), volatile memory, non-volatile memory, static random access memory (SRAM), dynamic random access memory (DRAM), flash memory, cache memory, or any other device capable of storing information. Mass storage memory device (32) may include data storage devices such as a hard drive, optical drive, tape drive, non-volatile solid state device, or any other device capable of storing information.

Processor (28) may operate under the control of an operating system (40) that resides in memory (30). Operating system (40) may manage computer resources so that computer program code embodied as one or more computer software applications, such as an application (42) residing in memory (30), may have instructions executed by processor (28). In an alternative embodiment, processor (28) may execute the application (42) directly, in which case operating system (40) may be omitted. One or more data structures (44) may also reside in memory (30), and may be used by processor (28), operating system (40), or application (42) to store or manipulate data.

I/O interface (34) may provide a machine interface that operatively couples processor (28) to other devices and systems, such as network (24) or external resource (38). Application (42) may thereby work cooperatively with network (24) or external resource (38) by communicating via I/O interface (34) to provide the various features, functions, applications, processes, or modules comprising embodiments of the invention. Application (42) may also have program code that is executed by one or more external resources (38), or otherwise rely on functions or signals provided by other system or network components external to computer system (26). Indeed, given the nearly endless hardware and software configurations possible, persons having ordinary skill in the art will understand that embodiments of the invention may include applications that are located externally to computer system (26), distributed among multiple computers or other external resources (38), or provided by computing resources (hardware and software) that are provided as a service over network (24), such as a cloud computing service.

HMI (36) may be operatively coupled to processor (28) of computer system (26) in a known manner to allow a user to interact directly with computer system (26). HMI (36) may include video or alphanumeric displays, a touch screen, a speaker, and any other suitable audio and visual indicators capable of providing data to the user. HMI (36) may also include input devices and controls such as an alphanumeric keyboard, a pointing device, keypads, pushbuttons, control knobs, microphones, etc., capable of accepting commands or input from the user and transmitting the entered input to processor (28).

A database (46) may reside on mass storage memory device (32) either on computer (26) or on another similar computer, and may be used to collect and organize data used by the various systems and modules described herein. Database (46) may include data and supporting data structures that store and organize the data. In particular, database (46) may be arranged with any database organization or structure including, but not limited to, a relational database, a hierarchical database, a network database, or combinations thereof. A database management system in the form of a computer software application executing as instructions on processor (28) may be used to access the information or data stored in records of database (46) in response to a query, where a query may be dynamically determined and executed by operating system (40), other applications (42), or one or more modules.

### A. Air and Vacuum System

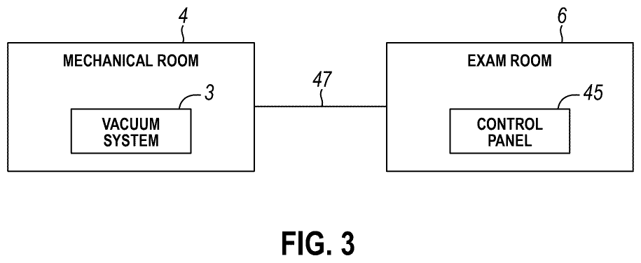

As shown in FIGS. 3-6, vacuum system (3) is disposed in a mechanical room (4), used for placement of equipment such as vacuum systems (3) and air compressors separate and spaced apart from an exam or treatment room (6) where a patient will be located and dental procedures will be performed. Vacuum system (3) generally includes vacuum assembly (9). Vacuum assembly (9) comprises a vacuum unit (11) operatively connected to a separator (14). Vacuum unit (11) is disposed within a housing (12) and separator (14) is positioned vertically above vacuum unit (11) for collecting the incoming air, fluids, and materials suctioned in via vacuum unit (11) and allowing separation of solid and liquid materials from the air as it passes through separator (14).

FIGS. 3-5 show an exemplary illustration of certain air handling lines for vacuum assembly (9), including inlet line (10) from the exam room to separator (14), and outlet line (62) from separator to vacuum unit (11). In other embodiments, inlet line (10) may enter horizontally at the side of separator. Inlet line (10) entering horizontally at the side of separator can result in circular or more vortex-like air flow within the separator (14), which can lead to more effective separation and collection of solids and liquids in the separator (14). Drain assembly (18) used to empty separated solids and liquids from the separator (14), vacuum relief valve (66) which relieves vacuum pressure in case of an obstructed vacuum line, and vacuum gage (68) used to measure vacuum pressure in the separator (14).

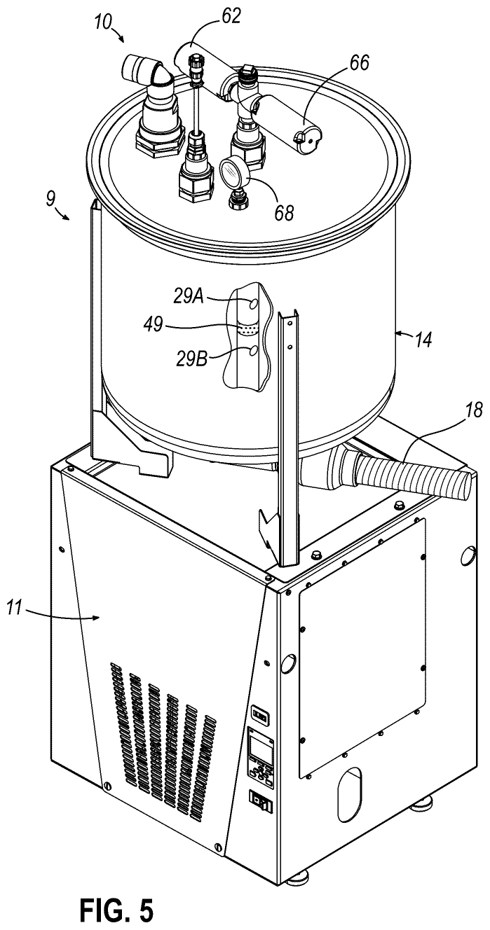

In certain situations, it can be beneficial to filter smaller particles and corrosive vapors to prevent these elements from getting downstream to pump components of vacuum unit (11) and ensure long service life of the vacuum unit (11). In some versions of vacuum assembly (9), separator (14) includes a filter (49) (see FIG. 5) used to filter air that enters the outlet line (62), although filter (49) may represent any filter in any portion of vacuum system (3). Filter (49) can be multiple stages or a single stage and in certain embodiments of the present invention can be placed within the separator (14). In certain preferred embodiments of the present invention filter (49) comprises a first stage filter made of stainless steel media (which aids in condensing and precipitating out vapors) followed by a second stage comprised of paper or other fiber media (which filters particulates in addition to further vapor filtration). In order to facilitate timely maintenance of filter (49), certain embodiments of the present invention may include pressure sensors (29) (described in further detail hereinbelow) before and after said filter (49) to allow measurement of pressure drop across filter and use such measurements to communicate the status of filter (49) or the need for maintenance of filter (49) or mechanisms related to filter (49) to end users using device communication features described elsewhere herein.

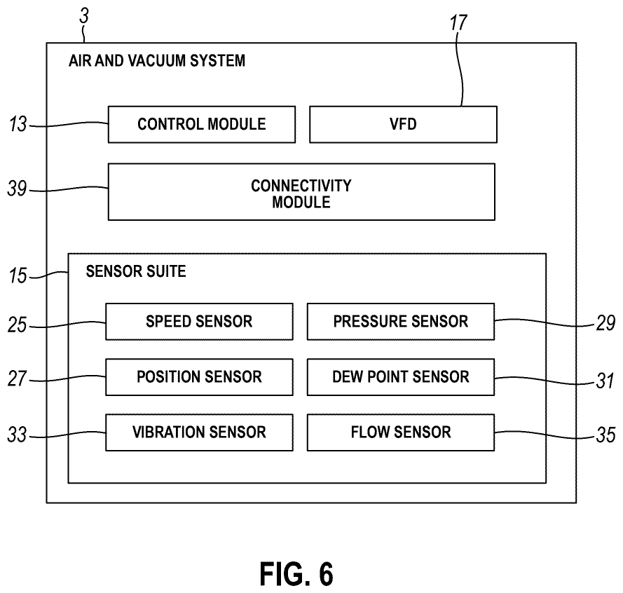

As shown in FIG. 6, vacuum system (3) further includes a control module (13). Control module (13) may conform to the above-described computer (26) or may include various sub-components or features described therewith. In some versions of vacuum system (3), a sensor suite (15) is connected to control module (13) to enable collection of data at various location and with respect to various elements within vacuum system (3). The data collected by sensor suite (15) may be utilized either directly or indirectly by control module (13) to increase the efficiency of vacuum system (3), diagnose problems, or provide preventative maintenance alerts. Control module (13) may be operably connected to analytics system (7) to pass sensor data on for analysis by analytics system (7). Control module (13) may be operably connected to a control panel (20) disposed on the exterior surface of housing (12). Control panel (20) allows a user to manipulate or actuate certain routines of control module (13) such as shutting down vacuum unit (11) for maintenance or running diagnostics.

Vacuum assembly (9) further includes a variable frequency drive (17), hereinafter “VFD (17),” operably connected to an electric motor (19). VFD (17) drives motor (19), which is configured to operate the vacuum functionality of vacuum unit (11) by turning internal claws (not shown) to create suction. In some versions of vacuum system (3), VFD (17) controls the speed and torque of motor (19) by varying the input frequency and voltage. In some versions, VFD (17) first converts incoming AC power to DC, and then VFD (17) synthesizes this DC power back into AC power at the desired frequency. By precisely controlling the frequency and voltage, VFD (17) allows motor (19) to operate at different speeds and loads, improving efficiency and extending the life of motor (19). Many of the sensors within sensor suite (15) may be coupled with VFD (17) to provide real-time monitoring and enhanced control over the operations of motor (19).

One benefit of using a VFD (17) to control vacuum system electric motor (19) is that certain functionality already in the VFD (17) may be used to directly or indirectly obtain certain data and thus limit the number sensors needed under certain circumstances. By way of example but not limitation, VFD (17) may in certain embodiments be used to obtain motor speed, peak motor current, and motor runtime, thus eliminating the need for separate sensors to perform these functions.

Sensor suite (15) may include a current sensor (21) for monitoring the amount of current drawn by motor (19) or other components of the vacuum system (11). Current sensor (21) may provide real-time feedback to VFD (17) and thus allow VFD (17) to adjust motor (19) speed accordingly. Current sensing and adjustments may help protect motor (19) from overload conditions. Similarly, sensor suite (15) may include a voltage sensor(s) (22). Voltage sensor(s) (22) may monitor the line voltage supplied to the system and voltage level provided to motor (19).

Sensor suite (15) may include a temperature sensor (23). Temperature sensor (23), or multiple temperature sensors (23) may be located in or proximate various components of vacuum system (3) to monitor heat generated during operation. For example, temperature sensor (23) may be located in or near VFD (17) or motor (19) and monitor the heat generated during operation of motor (19) on either a surface or air flowing thereby. Excessive heat can damage VFD (17) or motor (19), so temperature sensor (23) feeds this data back to the VFD (17), control module (13), or analytics system (7) to decrease speed of motor (19) or initiate a shutdown all or certain components of vacuum system (3) to prevent damage.

Sensor suite (15) may include a speed sensor (25) and/or a position sensor (27). Speed sensor (25) may measure the rotation speed of the motor shaft (not shown) within motor (19). This data is thereby provided to VFD (17) or control module (13) to allow precise control of the speed of motor (19). Some versions of speed sensor (25) may be embodied in magnetic pickups, hall effect sensors, and optical sensors. Speed sensor (25) may be utilized to extend the life of motor (19) by maintaining an exact target speed for maximum efficiency. Maintaining efficiency within vacuum system (3) may require knowledge of precise positioning of components within motor (19), particularly measurements of the actual position of the shaft of motor (19). Thus, position sensor (27) may be embodied in a rotary encoder, either as an incremental or absolute encoder. In those versions where position sensor (27) is an incremental style encoder, position sensor (27) may provide information about a change in position, but not the absolute position of the shaft of motor (19). In contrast, in those versions where position sensor (27) is an absolute style encoder, position sensor (27) may provide a unique output for each shaft position, allowing VFD (17) or control module (13) to know the exact position of the shaft of motor (19) at all times.

With respect to both speed sensor (25) and position sensor (27), the sensor data may be fed back to VFD (17) and/or control module (13), which then adjusts the voltage and frequency of the power supplied to motor (19) to achieve the desired speed or position. This closed-loop control provides very accurate control of motor (19) and allows for efficient operation.

Position sensor(s) (27) may also be used to detect the position or status of valves, switches, or other components in vacuum system (3), providing feedback on their functioning and allowing for proper control and operation.

As noted earlier, sensor suite (15) may include a pressure sensor (29). Pressure sensor (29) or multiple pressure sensors (29) may be utilized throughout vacuum system (3) to aid in maintaining efficiency, diagnose issues, and guide preventative maintenance, as pressure sensor(s) (29) measure the pressure levels in vacuum system (3), allowing for monitoring and control of airflow and suction power. In some versions of sensor suite (15), pressure sensor (29) may be used in connection with motor (19) to provide feedback to VFD (17) or control module (13) to adjust the speed of motor (19) and maintain the desired pressure level. The difference in pressure between the two pressure sensors (29) enables the detection of clogged filters or other obstructions that may impact system performance when pressure sensors (29) are positioned in other areas of vacuum system (3). Pressure differentials based on the difference in pressure readings between two specific points in vacuum system (3) may be taken at any relevant area or element and may be used for leakage detection, filter condition monitoring, system and performance optimization, safety monitoring, preventative maintenance, etc.

For example, as shown in FIG. 5, pressure sensor (29A) is disposed upstream of filter (49) and configured to provide a first pressure level, while pressure sensor (29B) is disposed downstream of filter (49) and configured to provide a second pressure level. Each pressure sensor (29A, 29B) may provide sensor data to VFD (17), control module (13), or analytics system (7) for analysis and the delta between the first pressure level and the second pressure level may be used or compared to a predetermined threshold. If the pressure differential is greater than the threshold, an alert may be generated and various appropriate actions taken in response to the alert.

Sensor suite (15) may include a dew point sensor (31). Dew point sensor (31) is used to measure the moisture content in the air within vacuum system (3), providing information on humidity levels that can impact the performance and effectiveness of the various components within vacuum system (3). Dew point sensor (31) may be utilized to prevent condensation by measuring the moisture level in the air. Condensation can lead to water buildup, which may cause corrosion and damage to system components. By monitoring the dew point via dew point sensor (31), VFD (17) or control module (13) can adjust air temperature or humidity levels to avoid reaching the dew point and minimize the risk of condensation. Further, monitoring the dew point over time can help indicate potential issues in vacuum system (3). If the dew point starts deviating from the expected range, it may be a sign of filter clogging or other problems that require maintenance. Early detection of issues through dew point sensor (31) can be used to alert the user for preventative maintenance and thus reduce downtime and more costly repairs.

Sensor suite (15) may include a vibration sensor (33). Vibration sensor (33) may be used to detect any abnormal vibrations or movements in vacuum system (3), helping identify potential issues such as motor or component malfunctions. By monitoring vibrations, vibration sensor (33) can identify potential mechanical issues or imbalances within the system's components. Early detection of abnormal vibrations allows for timely maintenance and minimizes the risk of costly breakdowns, ensuring continuous and reliable operation. Additionally, vibration sensor (33) aids in optimizing system performance, as it may help provide useful data for fine-tuning the settings within vacuum system (3) for smoother and quieter operation during dental procedures. Similar to the other sensors discussed within sensor suite (15), vibration sensor (33) may act as a component of the preventative maintenance strategy for vacuum system (3). By continuously monitoring vibration levels and comparing them to pre-established baseline values, vibration sensor (33) can detect any gradual increase in vibrations, indicating potential wear or deterioration of components. This proactive monitoring enables dental offices to schedule maintenance before critical failures occur, minimizing downtime and reducing repair costs.

Sensor suite (15) may include a flow sensor (35). Flow sensor (35) may be positioned within vacuum system (3) to derive data on the flow rates of air or fluids in vacuum unit (11). Flow rate data may allow for precise control and regulation of the performance of vacuum system (3), in an attempt to ensure that the airflow and suction levels meet the specific requirements of dental procedures. As will be discussed in greater detail below, dental professionals can monitor and adjust the flow rates in real-time through a control panel disposed within exam room (6), providing them with greater and more immediate control over the treatment environment. Further, and similar to other sensors in sensor suite (15), by detecting any fluctuations or anomalies in the flow rates, flow sensor (35) can provide early warnings of potential blockages or obstructions within vacuum system (3), preventing disruptions and minimizing risk of damage to vacuum system (3).

Sensor suite (15) may include an environmental sensor (37). Environmental sensor (37) may detect various environmental factors, such as environmental humidity, environmental temperature, air quality and airborne contaminants. VFD (17) and/or control module (13) may utilize the data provided by environmental sensor (37) by continuously monitoring environmental humidity, temperature, etc., and logging this data and adjusting performance specifications accordingly.

Any of the above noted sensors within sensor suite (15) may be located in any desired area or be associated with any element within vacuum system (3) to increase efficiency, diagnose problems, or aid in preventative maintenance. Further, multiple versions of any of the above noted sensors within sensor suite (15) may be disposed within vacuum system (3). These sensors, when integrated into vacuum system (3), can provide valuable data for monitoring, optimizing performance, and facilitating preventative maintenance, ultimately enhancing the overall efficiency and reliability of vacuum system (3) in a dental office setting.

While VFD (17) may be used to fine tune and control various features of motor (19) and elements associated with motor (19), control module (13) may receive the same or different data from sensor suite (15) and act accordingly to control various other features of vacuum system (3). For example, in some versions of vacuum system (3), VFD (17) may be configured to focus on the operation of motor (19) of vacuum unit (11), while control module (13) may be configured to focus on the operation of non-motor features. In other versions, some or all of the functionality of control module (13) may be merged into VFD (17). In other versions, some or all of the functionality of VFD (17) may be merged into control module (13). VFD (17) and/or control module (13) may be used to track run time of various components and report this information to analytics system (7), along with any other calculations, analytics, or data that is collected by sensor suite (15) or derived from other variables such as power consumption or element failures. Information and data may be analyzed in full or part on VFD (17) and/or control module (13), or some or all of the collected raw data may be passed along to analytics system (7) for calculations or analysis.

VFD (17) or control module (13) may include a connectivity module (39) for transmitting data between vacuum system (3) and exam room control system (5) or analytics system (7) via network (24). Connectivity module may utilize wireless capabilities and thus be encased in plastic for cooperation with radio frequency (RF) signals, or may utilize WiFi, Bluetooth Low Energy (BLE), LTE, or any other connectivity protocol to transmit data. Connectivity module (39) may also be hard wired to network (24) via a common network cable or wiring.

As described above, sensor suite (15) provides a window into all of the various components and environments within vacuum system (3) and the sensor data collected by each sensor in sensor suite (15) may be used for advanced system analytics.

### B. Analytics System

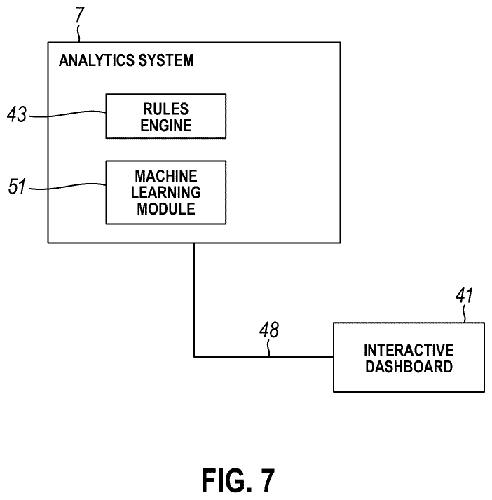

As shown in FIGS. 1 and 7, data acquired from vacuum system (3) via sensor suite (15) and various other data acquisition components and sensor data may be passed to analytics system (7) for further analysis, rule engine filtering, or any other desired mechanism for operating on the collected data. Vacuum system (3) may be configured with a cloud-based analytics system (7) for collecting data from vacuum system (3) as well as other devices or connectable products within the dental office such as examination chairs, lights, sterilizers, and imaging equipment. This raw and/or synthesized data may be provided to users via an interactive dashboard (41) that a user can operate and actuate to provide additional functionality or reveal other data or indicators. For example, raw runtime data may be passed to analytics system (7) and utilized to calculate wear and tear on individual components within vacuum system (3) with preventative maintenance alerts generated based on the calculations done “in the cloud” by analytics system (7). In some cases, the analytics system (7) may also analyze data from multiple vacuum systems across different dental offices to identify broader trends or patterns in component wear and system performance.

Interactive dashboard (41) may take the form of a web interface accessible by the user via a personal computer or similar computing device, or may be offered in the form of a mobile application for use on a mobile computing device such as a smart phone or tablet. The dashboard may provide real-time status updates, historical performance data, and customizable alerts based on user-defined parameters. Interactive dashboard (41) may be provided on control panel (45) in exam room (6), allowing dental practitioners to monitor vacuum system (3) status without leaving their workspace. In some implementations, interactive dashboard (41) may also be provided to a servicing company to review and monitor clients' vacuum systems (3) offsite, enabling proactive maintenance and support. Interactive dashboard (41) collects and transmits data via connection (48), which may take the form of a wired or wireless connection and may leverage network (24). The connection may utilize various protocols such as Wi-Fi, Bluetooth, Ethernet, or cellular networks to ensure reliable data transmission.

Analytics system (7) may have a rules engine (43) built to act upon acquired data and prevent maintenance or component failure timelines or progress. Rules engine (43) may be built to perform specific activities both passively, by tracking and contemplating issues based on incoming ongoing data, and also actively via a keypress or actuation by a user. In some cases, rules engine (43) may employ advanced statistical models and machine learning algorithms to improve the accuracy of its predictions over time with respect to preventative maintenance. Analytics system (7) may be configured to preemptively alert a user to potential problems with respect to vacuum system (3), order maintenance items or services, provide status or usage reports, or reconfigure elements within vacuum system (3) on the fly to increase performance or reduce downtime. For instance, analytics system (7) may automatically adjust the variable frequency drive (17) settings based on usage patterns to optimize energy efficiency and component longevity. Analytics system (7) may also be provided as an “add on” service by the vendor associated with vacuum system (3) and thus may be an optional component to connected vacuum system with sensor suite (1). This modular approach allows dental practices to customize their vacuum system (3) based on their specific needs and budget constraints.

Artificial intelligence or machine learning may be incorporated into rules engine (43) to provide additional analytics features. The inclusion of artificial intelligence or machine learning within rules engine (43) further enhances the capabilities of analytics system (7), as these features may continuously adapt and optimize system functionality over time. By dynamically adjusting to the specific needs and usage patterns of the particular dental office, analytics system (7) may refine its predictions and become increasingly precise and efficient in generating actionable insights or predict/prevent failures or future maintenance needs at the granularity level of an individual office. The algorithms may analyze complex patterns in sensor data, such as subtle changes in vibration signatures or power consumption, to detect early signs of component degradation that might be missed by traditional rule-based systems.

To that end, in some versions of the present disclosure, analytics system (7) includes a machine learning module (51) configured to dynamically update alert thresholds of rules engine (43) based on continuously collected sensor data and historical performance data. Machine learning module (51) is implemented using algorithms such as neural networks, support vector machines, decision trees, or ensemble methods like random forests or gradient boosting. Machine learning module (51) receives inputs (e.g., temperature, vibration, pressure, dew point) from sensor suite (15) to establish baseline operating parameters and detect deviations. When abnormal trends (such as a gradual increase in temperature or vibration) occur, machine learning module (51) recalibrates rules engine (43) thresholds in real time or at scheduled intervals to flag early anomalies or reduce false positives. This adaptive thresholding may account for seasonal variations, changes in usage patterns, or the natural aging of components.

In addition, machine learning module (51) may output a preventative maintenance alert that includes a recommended maintenance schedule or specific remedial actions, such as scheduling filter cleaning or inspecting air pathways, which can be displayed on control panel (20) or transmitted remotely. The module may also prioritize maintenance tasks based on their predicted impact on vacuum system (3) performance and potential downtime, helping dental practices optimize their maintenance schedules and resource allocation.

Rules engine (43) may be dynamic, in that rules engine (43) is continuously updated based on decision logic using real-time sensor data and historical metrics stored in database (46) or a cloud-based repository. By employing data analysis techniques such as trend analysis, moving averages, weighted averages, and more advanced methods like time series forecasting or anomaly detection algorithms, either in connection with machine learning module (51) or by way of other heuristics, rules engine (43) adjusts its thresholds to reflect changes in operating conditions and component aging. This adaptive capability ensures that preventative maintenance alerts remain timely and accurate, providing dental practitioners with actionable insights to preempt component degradation and minimize system downtime.

The rules engine (43) may also incorporate external data sources, such as manufacturer specifications, environmental conditions, or even data from similar systems in other dental practices, to further refine its predictive capabilities. This holistic approach to data analysis allows for more comprehensive and context-aware decision-making.

Rules updates for rules engine (43) may also be done manually through interactive dashboard (41) or any other mechanism for updating the rules within rules engine (43), including uploading a rules file or otherwise overwriting the current rules. A technician may upload a new set of rules to rules engine (43) via interactive dashboard (41) while on site for a service call, or rules updates may be pushed to rules engine (43) via network (24) at periodic intervals. This flexibility allows for rapid adaptation to new insights, regulatory changes, or manufacturer recommendations. In some implementations, analytics system (3) may provide a sandbox environment where new rules can be tested and validated before being applied to the live system, ensuring that updates do not negatively impact vacuum system (3) performance or reliability.

Setting up analytics system (7) to communicate with vacuum system (3) may require a mobile computing application (not shown) or some other initial startup procedure via localized Wi-Fi or network interface with vacuum system (3) in or near mechanical room (4). This setup process may involve steps such as device discovery, authentication, and initial configuration of communication parameters. The mobile application may guide users through the setup process, including network configuration, sensor calibration, and initial system checks. In some cases, the setup process may also include a learning phase where analytics system (7) establishes baseline performance metrics for the specific installation.

Once configured, the analytics system (7) may perform regular self-diagnostics to ensure ongoing connectivity and data integrity. In the event of communication disruptions, analytics system (7) may have fail-safe mechanisms to continue essential operations and local data logging until connectivity is restored. This robust setup and maintenance process ensures that the analytics system (7) remains a reliable and integral part of the dental practice's operations, providing continuous insights and support for optimal vacuum system (3) performance.

### C. Exam Room Control System

Exam room control system (5) allows users to monitor and control various parameters related to the operation of vacuum system (3) directly from within exam room (6) via a control panel (45). Control panel (45) may take the form of a tablet PC, touchscreen display, or other wireless or wired computing device. In some implementations, control panel (45) may be a wall-mounted unit with a user-friendly interface, while in others, it may be a portable device that can be easily moved around exam room (6). Control panel (45) may be strategically placed on a wall of exam room (6) for optimal viewing and accessibility while the dental practitioner is treating a patient, preparing exam room (6) for a patient, or cleaning exam room (6) after a dental procedure.

Exam room control system (5) provides convenient and efficient control over vacuum system (3), directly from within the exam room (6). This integration significantly enhances workflow efficiency, as a dental practitioner does not have to leave a patient and travel to mechanical room (4) to attend to vacuum system (3). Various tubing, hoses, wiring, and circuitry (hereinafter “connecting elements (47)” shown in FIG. 3) are provided to connect the system features of vacuum system (3) disposed generally in mechanical room (4) to the system features of exam room control system (5) disposed generally within exam room (6). Connecting elements (47) facilitate the control and feedback between control panel (45) and vacuum system (3), ensuring seamless communication and real-time data exchange.

Dental practitioners can use control panel (45) to monitor system parameters in real-time. Some versions of control panel (45) may provide a comprehensive display of data collected by sensor suite (15) and various other components within vacuum system (3). The display of control panel (45) provides insights into the system's performance and environmental conditions within the mechanical room (4). This may include graphical representations of pressure levels, temperature readings, vibration data, and flow rates. The interface may also feature trend analysis tools, allowing practitioners to view historical data and identify patterns or anomalies over time.

Thus, dental professionals can make informed decisions and swiftly adjust system settings to match the requirements of various dental procedures and immediately respond to any deviations or abnormalities. For example, if there is a decrease in pressure, an increase in temperature, or any unusual vibrations detected by the sensors, control panel (45) may be configured to generate a real-time alert on the display screen of control panel (45), and optionally also incorporate a sound with the alert. These alerts may be customizable, allowing practitioners to set thresholds based on their specific needs or preferences. The system may also employ color-coding or visual indicators to quickly communicate the severity of an issue, ranging from minor notifications to critical alerts requiring immediate attention.

This ensures dental practitioners are promptly informed of the issue, allowing them to take swift corrective actions and prevent potential disruptions during dental treatments. Further, these corrective actions may be taken via control panel (45) itself, allowing the dental practitioner to stay with the patient in exam room (6). This approach enhances system reliability, minimizes downtime, and ensures a smooth and uninterrupted workflow in the dental office. Any alert described herein may be displayed on control panel (45). Alerts depicted on control panel (45) may actuate functionality to prompt the user/viewer of control panel (45) to take action via user input into control panel (45). The system may also provide step-by-step guidance for resolving issues, which can be particularly helpful for less experienced staff members.

Beyond monitoring capabilities, exam room control system (5) offers control of vacuum system (3) functionalities from within exam room (6). Dental professionals can adjust the airflow rate, vacuum suction strength, and other parameters of vacuum system (3) within exam room (6) via control panel (45). The interface may provide intuitive controls, such as sliders or preset buttons, for quick adjustments. Additionally, the system may offer the ability to create and save custom presets for different procedures or practitioners, streamlining the process of configuring the system for specific needs.

Fine-tuning these settings allows for optimized system performance and tailor-made adjustments based on specific patient needs and treatment requirements. For instance, a practitioner may need higher suction power for a complex extraction procedure, while a routine cleaning might require gentler settings. The ability to make these adjustments in real-time, without leaving the patient's side, contributes to more efficient and responsive patient care.

In some implementations, exam room control system (5) may also integrate with other dental office systems, such as patient management software or scheduling tools. This integration could allow for automatic adjustment of vacuum system (3) settings based on the scheduled procedure or patient preferences, further streamlining workflow and enhancing personalized care. The system may also support remote access capabilities, enabling authorized technicians to diagnose issues or perform software updates without needing to be physically present in the dental office, potentially reducing downtime and maintenance costs.

### II. Method of Use

The method for operating a connected vacuum system with a sensor suite begins by disposing a vacuum system, similar to vacuum system (3) described above, in a mechanical room of a dental office. Some versions of vacuum system include a vacuum assembly, a control module, and a sensor suite, similar to those elements described above. The vacuum assembly may comprise components such as those described above as separator (14), vacuum unit (11), and variable frequency drive (17), all working in concert to provide efficient suction capabilities.

The sensor suite is equipped with a plurality of sensors capable of monitoring various parameters within the vacuum system and more particularly within the components of vacuum assembly. These parameters include but are not limited to current, voltage, temperature, speed, position, environmental temperature, environmental humidity, pressure, dew point, vibration, and flow rate. For instance, the sensor suite may include a speed sensor to monitor motor rotation, a pressure sensor to track suction levels, and a vibration sensor to detect any abnormal oscillations that might indicate mechanical issues.

The interconnected nature of the vacuum system with the sensor suite allows for efficient data communication between the components. This integration may be facilitated through a connectivity module, which acts as a central hub for data collection and transmission. The connectivity module may utilize various communication protocols such as Wi-Fi, Bluetooth, or Ethernet to ensure seamless data flow.

Data is thereafter collected from the plurality of sensors within the sensor suite. These sensors are designed to continuously monitor the predetermined parameters during the operation of the vacuum system. The collected data provides real-time insights into the system's performance and environmental conditions within the mechanical room where the vacuum system is located. The data collection process may involve sampling at different frequencies for various parameters, allowing for both high-resolution monitoring of critical variables and efficient long-term tracking of slower-changing metrics.

To analyze and process the collected data, the method involves transmitting this data from the sensor suite to an analytics system, similar to analytics system (7) described above. This transmission is typically facilitated over a network, with the analytics system potentially located offsite or in the cloud. The data transmission from vacuum system to the analytics system allows for more comprehensive and sophisticated analysis of the system's performance, contributing to the identification of patterns, trends, and potential anomalies. The network connection may be secured using encryption protocols to ensure the confidentiality and integrity of the transmitted data.

By utilizing the analytics system, the collected data is analyzed to prevent maintenance needs and component failure timelines. The analytics system may employ algorithms and machine learning techniques to identify early signs of potential issues, wear and tear within the vacuum system, or diagnose current issues. For example, machine learning module (51) may use historical data to establish baseline performance metrics and detect deviations that could indicate impending failures. The system may also employ advanced statistical methods such as time series analysis or anomaly detection algorithms to identify subtle changes in system behavior.

Based on this analysis, the method may generate alerts regarding diagnosed issues, preventative maintenance, and reconfigurations or re-calibration commands for the components of vacuum system in an effort to reduce downtime. These alerts can be customized based on severity levels, allowing for appropriate responses ranging from routine maintenance scheduling to immediate intervention for critical issues.

An interactive dashboard may be provided to allow dental practitioners a mechanism to control and/or monitor vacuum system. The interactive dashboard may be provided via a web interface for access anywhere as desired or may alternatively be provided via a mobile application for use on mobile computing devices such as smart phones. This flexibility ensures that authorized personnel can access critical system information and controls regardless of their location, enhancing overall system management and response times.

In some versions of the dashboard, both real-time and historical performance data of the vacuum system is displayed to the user. This may include graphical representations of key metrics, trend analysis tools, and customizable widgets that allow users to focus on the most relevant information for their needs. Users can review the displayed data and make adjustments to match specific dental procedure requirements or react to alerts. The dashboard may also offer predictive/preventative insights, such as estimated time to next maintenance based on current usage patterns and historical data.

To enhance the usability and convenience of the connected vacuum system, an exam room control system with a control panel may be installed within the exam room. Interactive dashboard may be displayed on the control panel. This integration brings critical system controls and information directly into the clinical environment, streamlining workflow and improving responsiveness to system changes.

Through this control panel, dental practitioners can monitor the performance data displayed on the control panel in the exam room. The control panel may feature a user-friendly interface with touch-screen capabilities, allowing for intuitive navigation and control. Dental practitioners can access and adjust various system functionalities based on the real-time data from the sensor suite without leaving the patient and exam room. This may include adjusting suction power, initiating self-cleaning cycles, or fine-tuning system parameters to optimize performance for specific procedures.

The method may also incorporate adaptive learning capabilities, where the system continuously refines its predictive models based on actual outcomes and user interactions. For instance, if a practitioner frequently adjusts certain settings for particular procedures, the system could learn these preferences and suggest or automatically apply these optimizations in future similar scenarios.

In view of the above, the method for operating a connected vacuum system with a sensor suite offers dental practitioners an advanced, data-driven, and efficient way to view and control the system's performance and parameters. The combination of real-time data collection, analytics-driven predictions regarding preventative maintenance, and user-friendly exam room control interfaces enhances patient comfort, reduces downtime, and facilitates dental procedures within the exam room setting. This integrated approach not only improves the operational efficiency of the dental practice but also contributes to better patient care by ensuring optimal system performance and minimizing disruptions during treatments.

### III. Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A connected vacuum system with a sensor suite, comprising: (a) a vacuum system, wherein the vacuum system is disposed in a mechanical room and comprises: (i) a vacuum assembly comprising a vacuum unit and a separator, (ii) a sensor suite, wherein the sensor suite comprises a plurality of sensors, wherein each sensor in the plurality of sensors is configured to collect data from the vacuum assembly, and (iii) a control module, wherein the control module is configured to actuate the vacuum assembly, wherein the control module is configured to receive data from the sensor suite regarding the vacuum assembly, wherein the control module is configured to transmit data regarding the vacuum assembly; (b) an analytics system, wherein the analytics system is operably connected to the control module and configured to receive data regarding the vacuum assembly, wherein the analytics system is configured to analyze the received data and generate an alert based on comparing the data to a rules engine; and (c) an exam room control system, wherein the exam room control system is disposed in an exam room, wherein the exam room control system comprises a control panel operably connected to the control module, wherein the control panel is configured to display at least a portion of the data collected by the sensor suite, wherein the control panel is configured to receive user input and thereafter actuate the vacuum assembly via the control module.

### Example 2

The prior or any of the subsequent Examples, wherein the plurality of sensors includes a dew point sensor, wherein the dew point sensor is configured to detect moisture levels within the vacuum and/or compressor system and transmit a moisture level to the analytics system via the control module, wherein the analytics system is configured to analyze the received moisture level and generate an alert when the moisture level exceeds a predetermined threshold.

### Example 3

Any of the prior or subsequent Examples, wherein the analytics system is configured to analyze the moisture level and actuate an adjustment to the operation of the vacuum system to prevent condensation-related damage.

### Example 4

Any of the prior or subsequent Examples, wherein the plurality of sensors includes a vibration sensor, wherein the vibration sensor is configured to monitor vibrations within the vacuum system and transmit a vibration dataset to the analytics system via the control module, wherein the analytics system is configured to analyze the received vibration dataset and generate an alert when abnormal vibration patterns are detected within the vibration dataset.

### Example 5

Any of the prior or subsequent Examples, wherein the control panel is configured to display the moisture level, vibration dataset, and the alert.

### Example 6

Any of the prior or subsequent Examples, wherein the vacuum system may be adjusted via a prompt on the control panel in response to the alert.

### Example 7

Any of the prior or subsequent Examples, wherein the analytics system is configured to analyze the vibration dataset and actuate an adjustment to the operation of the vacuum system to prevent vibration-related damage.

### Example 8

Any of the prior or subsequent Examples, wherein the analytics system is configured to analyze the vibration dataset and detect frequency patterns associated with the failure of a bearing of the vacuum system, wherein the analytics system is configured to generate an alert when failure of the bearing is detected within the vibration dataset.

### Example 9

Any of the prior or subsequent Examples, wherein the analytics system is configured to analyze the vibration dataset and detect critical vibration levels of the vacuum system, wherein the analytics system is configured to automatically shut down the vacuum system upon detecting critical vibration levels.

### Example 10

Any of the prior or subsequent Examples, wherein the vacuum assembly includes a filter disposed in line with a stream of air within the vacuum assembly, wherein the plurality of sensors includes a first pressure sensor disposed upstream of the filter and configured to transmit a first pressure level to the analytics system via the control module, wherein the plurality of sensors includes a second pressure sensor disposed downstream of the filter and configured to transmit a second pressure level to the analytics system via the control module, wherein the analytics system is configured to analyze a pressure differential between the first pressure level and the second pressure level and generate an alert when the pressure differential exceeds a predetermined threshold. Example 11

Any of the prior or subsequent Examples, wherein the control panel is configured to display the pressure differential.

### Example 12

Any of the prior or subsequent Examples, wherein the analytics system comprises a machine learning module configured to receive sensor data collected by the plurality of sensors and dynamically update and recalibrate a set of alert thresholds in real-time based on current and historical sensor data to adaptively predict impending component failure.

### Example 13

Any of the prior or subsequent Examples, wherein the machine learning module is further configured to compare continuously collected sensor data to historical performance and automatically generate a preventative maintenance alert that includes one of a recommended maintenance schedule and a specific remedial action when the sensor data indicates an impending component degradation or failure.

### Example 14

Any of the prior or subsequent Examples, wherein the vacuum assembly comprises a variable frequency drive operably connected to an electric motor, wherein the variable frequency drive controls a speed of the electric motor by varying an input voltage, wherein the input voltage is based at least in part on data provided by the plurality of sensors.

### Example 15

A connected vacuum system with a sensor suite for use in a dental office, comprising: (a) a vacuum system, wherein the vacuum system includes a plurality of components, wherein the vacuum system is configured to discharge air from a mechanical room into an exam room for use in dental procedures, wherein the vacuum system is configured to provide suction from the exam room to the mechanical room for the removal of saliva and other fluids from the exam room; (b) a sensor suite, wherein the sensor suite comprises a plurality of sensors, wherein each sensor in the plurality of sensors is configured to collect data from at least one component of the plurality of components; (c) a control module, wherein the control module is configured to actuate the plurality of components, wherein the control module is configured to receive sensor data from the sensor suite regarding the plurality of components, wherein the control module is configured to transmit data regarding the plurality of components; (d) an analytics system, wherein the analytics system is operably connected to the control module and configured to receive sensor data regarding the plurality of components, wherein the analytics system is configured to analyze the received sensor data and generate an alert based on comparing the sensor data to a rules engine; and (e) a control panel, wherein the control panel is located in the exam room, wherein the control panel is operably connected to the vacuum system, wherein the control panel is configured to display at least a portion of the data collected by the sensor suite, wherein the control panel is configured to receive user input and thereafter actuate the plurality of components, via the vacuum system, based on the user input.

### Example 16

Any of the prior or subsequent Examples, wherein the plurality of sensors comprises at least one of a current sensor, a voltage sensor, a temperature sensor, a speed sensor, a position sensor, a pressure sensor, a dew point sensor, a vibration sensor, and a flow sensor.

### Example 17

Any of the prior or subsequent Examples, wherein the analytics system is configured to update the rules engine based on the sensor data.

### Example 18

Any of the prior or subsequent Examples, wherein the analytics system is configured to update the set of alert thresholds in real-time by analyzing trends and deviations in historical performance of the plurality of components based on the sensor data.

### Example 19

A method for operating a connected vacuum system with a sensor suite, comprising: (a) providing a connected vacuum system with a sensor suite comprising a vacuum assembly, a control module, and a sensor suite, wherein the sensor suite comprises a plurality of sensors for monitoring a plurality of parameters within the vacuum assembly; (b) collecting data from the plurality of sensors within the sensor suite, wherein the data includes one or more of current, voltage, temperature, speed, position, pressure, dew point, vibration, and flow rate; (c) transmitting the collected data to an analytics system over a network; (d) utilizing the analytics system to predict maintenance needs and component failure timelines based on the collected data; and (e) monitoring and adjusting at least one of the plurality of parameters via a control panel within an exam room.

### Example 20

Any of the prior or subsequent Examples, comprising the steps of: (a) generating an alert relating to a predication of component failure based on the collected data; and (b) displaying a graphic relating to the alert on the control panel within the exam room.

### IV. Miscellaneous

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A connected vacuum system with a sensor suite, comprising:
(a) a vacuum system, wherein the vacuum system is disposed in a mechanical room and comprises:
(i) a vacuum assembly comprising a vacuum unit and a separator,
(ii) a sensor suite, wherein the sensor suite comprises a plurality of sensors, wherein each sensor in the plurality of sensors is configured to collect data from the vacuum assembly, and
(iii) a control module, wherein the control module is configured to actuate the vacuum assembly, wherein the control module is configured to receive data from the sensor suite regarding the vacuum assembly, wherein the control module is configured to transmit data regarding the vacuum assembly;
(b) an analytics system, wherein the analytics system is operably connected to the control module and configured to receive data regarding the vacuum assembly, wherein the analytics system is configured to analyze the received data and generate an alert based on comparing the data to a rules engine; and
(c) an exam room control system, wherein the exam room control system is disposed in an exam room, wherein the exam room control system comprises a control panel operably connected to the control module, wherein the control panel is configured to display at least a portion of the data collected by the sensor suite, wherein the control panel is configured to receive user input and thereafter actuate the vacuum assembly via the control module.

2. The connected vacuum system of claim 1, wherein the plurality of sensors includes a dew point sensor, wherein the dew point sensor is configured to detect moisture levels within the vacuum system and transmit a moisture level to the analytics system via the control module, wherein the analytics system is configured to analyze the received moisture level and generate an alert when the moisture level exceeds a predetermined threshold.

3. The connected vacuum system of claim 2, wherein the analytics system is configured to analyze the moisture level and actuate an adjustment to the operation of the vacuum system to prevent condensation-related damage.

4. The connected vacuum system of claim 2, wherein the plurality of sensors includes a vibration sensor, wherein the vibration sensor is configured to monitor vibrations within the vacuum system and transmit a vibration dataset to the analytics system via the control module, wherein the analytics system is configured to analyze the received vibration dataset and generate an alert when abnormal vibration patterns are detected within the vibration dataset.

5. The connected vacuum system of claim 4, wherein the control panel is configured to display the moisture level, vibration dataset, and the alert.

6. The connected vacuum system of claim 4, wherein the vacuum system may be adjusted via a prompt on the control panel in response to the alert.

7. The connected vacuum system of claim 4, wherein the analytics system is configured to analyze the vibration dataset and actuate an adjustment to the operation of the vacuum system to prevent vibration-related damage.

8. The connected vacuum system of claim 4, wherein the analytics system is configured to analyze the vibration dataset and detect frequency patterns associated with the failure of a bearing of the vacuum system, wherein the analytics system is configured to generate an alert when failure of the bearing is detected within the vibration dataset.

9. The connected vacuum system of claim 4, wherein the analytics system is configured to analyze the vibration dataset and detect critical vibration levels of the vacuum system, wherein the analytics system is configured to automatically shut down the vacuum system upon detecting critical vibration levels.

10. The connected vacuum system of claim 1, wherein the vacuum assembly includes a filter disposed in line with a stream of air within the vacuum assembly, wherein the plurality of sensors includes a first pressure sensor disposed upstream of the filter and configured to transmit a first pressure level to the analytics system via the control module, wherein the plurality of sensors includes a second pressure sensor disposed downstream of the filter and configured to transmit a second pressure level to the analytics system via the control module, wherein the analytics system is configured to analyze a pressure differential between the first pressure level and the second pressure level and generate an alert when the pressure differential exceeds a predetermined threshold.

11. The connected vacuum system of claim 10, wherein the control panel is configured to display the pressure differential.

12. The connected vacuum system of claim 1, wherein the analytics system comprises a machine learning module configured to receive sensor data collected by the plurality of sensors and dynamically update and recalibrate a set of alert thresholds in real-time based on current and historical sensor data to adaptively predict impending component failure.

13. The connected vacuum system of claim 12, wherein the machine learning module is further configured to compare continuously collected sensor data to historical performance and automatically generate a preventative maintenance alert that includes one of a recommended maintenance schedule and a specific remedial action when the sensor data indicates an impending component degradation or failure.

14. The connected vacuum system of claim 1, wherein the vacuum assembly comprises a variable frequency drive operably connected to an electric motor, wherein the variable frequency drive controls a speed of the electric motor by varying an input voltage, wherein the input voltage is based at least in part on data provided by the plurality of sensors.

15. A connected vacuum system with a sensor suite for use in a dental office, comprising:
(a) a vacuum system, wherein the vacuum system includes a plurality of components, wherein the vacuum system is configured to discharge air from a mechanical room into an exam room for use in dental procedures, wherein the vacuum system is configured to provide suction from the exam room to the mechanical room for the removal of saliva and other fluids from the exam room;
(b) a sensor suite, wherein the sensor suite comprises a plurality of sensors, wherein each sensor in the plurality of sensors is configured to collect data from at least one component of the plurality of components;
(c) a control module, wherein the control module is configured to actuate the plurality of components, wherein the control module is configured to receive sensor data from the sensor suite regarding the plurality of components, wherein the control module is configured to transmit data regarding the plurality of components;
(d) an analytics system, wherein the analytics system is operably connected to the control module and configured to receive sensor data regarding the plurality of components, wherein the analytics system is configured to analyze the received sensor data and generate an alert based on comparing the sensor data to a rules engine; and
(e) a control panel, wherein the control panel is located in the exam room, wherein the control panel is operably connected to the vacuum system, wherein the control panel is configured to display at least a portion of the data collected by the sensor suite, wherein the control panel is configured to receive user input and thereafter actuate the plurality of components, via the vacuum system, based on the user input.

16. The connected vacuum system of claim 15, wherein the plurality of sensors comprises at least one of a current sensor, a voltage sensor, a temperature sensor, a speed sensor, a position sensor, a pressure sensor, a dew point sensor, a vibration sensor, and a flow sensor.

17. The connected vacuum system of claim 15, wherein the analytics system is configured to update the rules engine based on the sensor data.

18. The connected vacuum system of claim 17, wherein the analytics system is configured to update the set of alert thresholds in real-time by analyzing trends and deviations in historical performance of the plurality of components based on the sensor data.

19. A method for operating a connected vacuum system with a sensor suite, comprising:
(a) providing a connected vacuum system with a sensor suite comprising a vacuum assembly, a control module, and a sensor suite, wherein the sensor suite comprises a plurality of sensors for monitoring a plurality of parameters within the vacuum assembly;
(b) collecting data from the plurality of sensors within the sensor suite, wherein the data includes one or more of current, voltage, temperature, speed, position, pressure, dew point, vibration, and flow rate;
(c) transmitting the collected data to an analytics system over a network;
(d) utilizing the analytics system to predict maintenance needs and component failure timelines based on the collected data; and
(e) monitoring and adjusting at least one of the plurality of parameters via a control panel within an exam room.

20. The method of claim 19, comprising the steps of:
(a) generating an alert relating to a predication of component failure based on the collected data; and
(b) displaying a graphic relating to the alert on the control panel within the exam room.
